(19) United States
(12) Patent Application Publication
(10) Pub. No.: US 2009/0266794 A1
(43) Pub. Date: Oct. 29, 2009

(54) Arc Quenching Device With an Arc Quenching Material for a Circuit Breaker

(76) Inventors: Jürgen Heydendorf, Hennigsdorf (DE); Ralph Hohenberger, Brieselang (DE)

Correspondence Address: HARNESS, DICKEY & PIERCE, P.L.C., P.O. BOX 8910, RESTON, VA, 20195, US

(21) Appl. No.: 12/225,735

(22) PCT Filed: Mar. 28, 2007
(86) PCT No.: PCT/EP2007/052958

§ 371 Date: Sep. 29, 2008

(30) Foreign Application Priority Data
Mar. 29, 2006 (DE) 10 2006 015 306.5
Mar. 29, 2006 (DE) 10 2006015 305.7

(51) Int. Cl. H01H 9/30

(52) U.S. Cl. 218/149

(57) ABSTRACT

An arc quenching device is disclosed for an electrical switch having a plurality of arc quenching plates, which are arranged parallel to one another, and having at least one part composed of gassing plastic. In order to stabilize the arc, at least one embodiment of the invention provides for at least one part composed of gassing plastic to extend parallel to the arc running direction covering at least two of the quenching plates.

This application is the national phase under 35 U.S.C. § 371 of PCT International Application No. PCT/EP2007/052958 which has an International filing date of Mar. 28, 2007, which designated the United States of America and which claims priority on German application Nos. 10 2006 015 305.7 filed Mar. 29, 2006 and 10 2006 015 306.5 filed Mar. 29, 2006, the entire contents of each of which are hereby incorporated herein by reference.

### FIELD

At least one embodiment of the invention generally relates to an arc quenching device for an electrical switch, such as one with a plurality of arc splitters arranged parallel to one another and with at least one part consisting of gassing plastic, for example.

At least one embodiment of the invention furthermore generally relates to an electrical switch with such an arc quenching device.

### BACKGROUND

The use of gassing plastics in arc quenching devices is known per se. These “gassing” plastics are characterized by the fact that, in the event of an interaction with a switching arc, gaseous decomposition products are released from the surface of the plastics. The gaseous decomposition products, which are also known under the designation “hard gas”, result in an elevated pressure at the location of the arc quenching and therefore force the arc to be quenched more quickly.

Document DE 102 42 310 A1 discloses a line circuit breaker with a generic arc quenching device.—In the case of this known arc quenching device, the additional part consisting of gassing plastic is formed as a plate preferably from Ultramid® A3SK. This plate is provided in addition to the splitters or instead of the splitters and runs parallel to the splitters and therefore transversely with respect to the arc running direction. It is used for stabilizing the arc in the region of the splitters.

### SUMMARY

At least one embodiment of the invention, another solution for stabilizing the arc is disclosed.

According to at least one embodiment of the invention, the at least one part consisting of gassing plastic covers at least two of the splitters and in the process extends parallel to the arc running direction. In at least one embodiment, two of the gassing parts are provided in the form of areal strips, which extend beneath the splitters over all of the splitters for optimum stabilization of the arc. The gassing parts according to at least one embodiment of the invention can be retrofitted easily in terms of fitting technology, to be precise in particular also once the arc splitters have been caulked with insulating walls to form a splitter stack.

An example configuration of the at least one embodiment of the arc quenching device provides that the splitters are arranged between two arc guide plates, which run parallel to them, the two areal strips each being fixed on the two arc guide plates.—In order to fix them, the arc guide plates and the areal strips can be provided with corresponding latching means. In at least one embodiment, the arc guide plates can have projections, which engage in associated cutouts of the insulating walls 22. An additional hold for the areal strips can be formed by the insulating walls, which extend parallel to the arc running direction and which are used per se for fixing the splitters and the arc guide plates. In this case, in each case one of the flat sides of the two strips which run parallel to the insulating walls can be supported on one of the insulating walls.

A further example configuration of the invention provides that the gassing plastic is glass-fiber-reinforced.—This glass-fiber reinforcement has the effect of maintaining the structure even in the case of frequent interaction with arcs, with the result that, given comparably good stabilization of the arc, contamination of parts of a switching contact system arranged beneath the arc quenching device as a result of falling products of erosion is avoided.

Preferably, the gassing plastic in this case contains an additive consisting of red phosphor for the purpose of optimizing fire protection.—Thus, in particular the polyamide known by the injection molding trade mark Ultramid® A3X2G7 is used as gassing plastic.

### BRIEF DESCRIPTION OF THE DRAWINGS

An example embodiment of the novel arc quenching device is illustrated in FIGS. 1 to 5, in which:

FIG. 1 shows a schematic illustration of an electrical switch with an arc quenching device,

FIG. 2 shows a switching contact arrangement of the electrical switch, with which an arc quenching device according to an embodiment of the invention is associated,

FIG. 3 shows the arc quenching device shown in FIG. 2 in an exploded illustration, and

FIGS. 4 and 5 show the arc quenching device shown in FIG. 2 during and after fitting of the additional parts consisting of gassing plastic.

### DETAILED DESCRIPTION OF THE EXAMPLE EMBODIMENTS

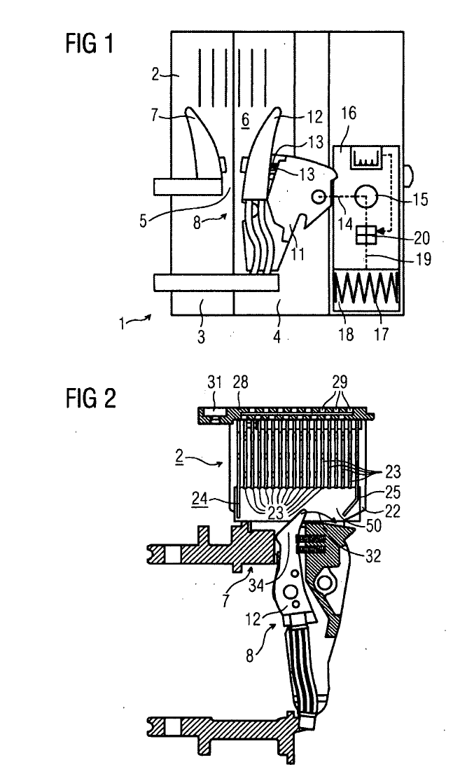

FIG. 1 shows an electrical switch 1 in the form of a low-voltage circuit breaker, which has a switching contact system, an arc quenching device 2 associated with the switching contact system and a switching pole housing formed from two housing shells 3 and 4. The switching pole housing in this case forms an integrated switching chamber 5 for accommodating the switching contact system and an integrated quenching chamber 6, which is open towards the switching chamber 5, for accommodating the arc quenching device 2. The switching contact system includes a fixed switching contact arrangement 7 and a movable switching contact arrangement 8. The movable switching contact arrangement 8 in this case has a pivotable contact carrier 11 and a plurality of movable switching contacts 12 in the form of contact levers. The movable switching contacts 12 are capable of pivoting parallel to one another and are supported in a sprung manner, under prestress, on the contact carrier 11 by way of, in each case, two contact force springs 13.

The movable switching contact arrangement 7 is coupled in a known manner to a switching shaft 15 via a lever arrangement 14, which is only illustrated schematically in FIG. 1. At the same time, the switching shaft 15 is used for driving further switching contact systems (not illustrated in any more detail), which are arranged parallel to the switching contact system shown and to which in each case one further (likewise not illustrated) arc quenching device is associated. The switching shaft 15 can be moved, by way of a drive apparatus 16, from an off position, in which the switching contact systems are open, into an on position, in which the switching contact systems are closed. When the switching shaft 15 moves over into its on position, the contact force springs 13 are further tensioned. The drive apparatus 16 has a drive 18, which is provided with a spring-energy store 17, a drive train 19, which couples the drive 18 to the switching shaft 15, and a switching mechanism 20.

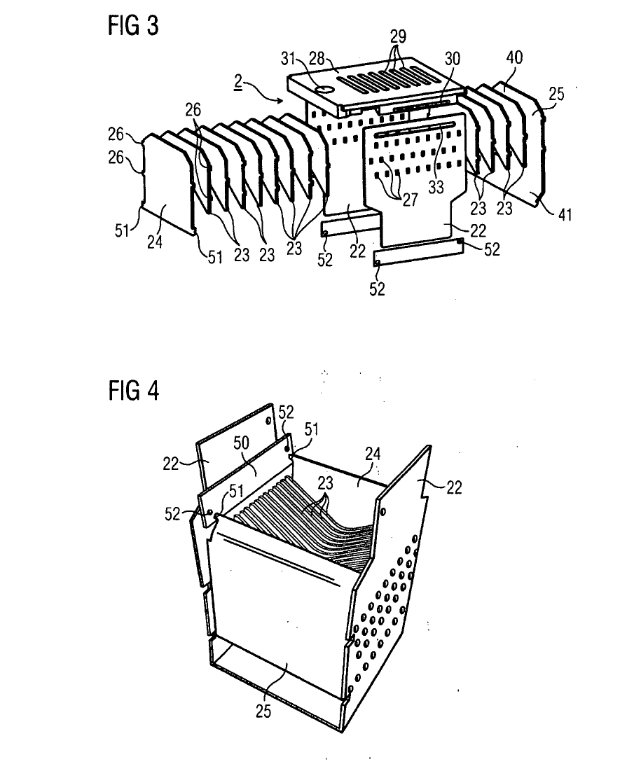

As shown in FIGS. 2 and 3, each of the arc quenching devices 2 includes two insulating walls 22 consisting of fiber or erosion-resistant plastic and arc splitters 23 and arc guide plates 24, 25, consisting of sheet steel. The arc splitters 23 and the arc guide plates 24, 25 are provided with pins 26, which are inserted into holes 27 of the insulating walls 22 and caulked (riveted). This results in a splitter stack, which is inserted into the quenching chamber 6. The arc quenching device furthermore has a terminating cover 28, which is provided with blowout slots 29, lateral attachments 30 and a passage opening 31. The lateral attachments 30 engage in slits 33 of the insulating walls 22 in order to fasten the cover 28 on the splitter stack. In order to fasten the arc quenching device 2 in the quenching chamber 6, a fastening screw (not illustrated) is used which engages, in such a way as to engage through the passage opening 31, into a threaded bore associated with said passage opening of one of the two housing shells 3 of the switching pole housing.

As shown in FIG. 2, the flat arc guide plate 24, which forms an outer side of the splitter stack running perpendicular to the insulating plates, is associated with the fixed switching contact arrangement 7. The arc guide plate 25 which likewise forms an outer side of the splitter stack running perpendicular to the insulating plates is associated with the movable switching contact arrangement 8. It has a first part 40, which runs parallel to the arc splitters 23 and a bent-back portion 41, which is inclined in the opposite direction to the opening direction 32 of the movable switching contacts 12. The free end of this bent-back portion 41 is at a short distance from the movement paths of the free ends, which are in the form of arc horns 34, of the movable switching contacts 12. This ensures optimum transfer of the arc base from the arc horns 34 to the arc guide plate 25. The arc running direction in this case corresponds to the opening direction 32.

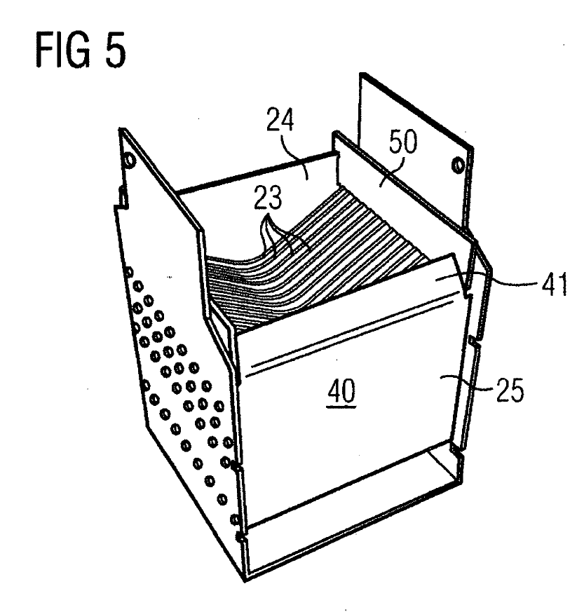

As shown in FIGS. 4 and 5, two additional parts 50 in the form of areal strips, whose flat sides run parallel to the insulating walls, are supported on mutually facing inner sides of the insulating walls 22 beneath the arc guide plates 23. These additional parts 50 consist of gassing plastic, which contains an additive of red phosphor as the addition for fire protection. Furthermore, the gassing plastic has reinforcing materials in the form of glass fibers for reinforcing purposes. Preferably, the gassing parts 50 consist of the polyamide plastic PA 66, which is known under the trade name Ultramid® A3X2G7 and is characterized by a low melting viscosity and which has a mass component of glass fibers of 35% in addition to the red phosphor. The two strips each have a length of 98 mm, a width of 22 mm and a thickness of 3 mm.

The strips are fixed on the arc guide plates by way of corresponding latching device(s). In this example embodiment case, the arc guide plates have projections 51 on their edges facing the two insulating walls 22, which projections 51 engage in associated cutouts 52 in the form of bores in the insulating walls 22.

The fitting of the two areal strips only takes place once the arc splitters 23 and the arc guide plates 24, 25 have been caulked (riveted) to the insulating walls 22 to form the splitter stack. In this case, the insulating walls 22 are bent up elastically outward for a short period of time in order to position the areal strips on that side of the splitter stack which faces the switching contact system beneath the splitters in such a way that the projection 51 of the arc guide plates 24, 25 can engage in the associated cutouts 52 of the areal strips.

Owing to the additional parts 50 consisting of gassing plastic, in particular of Ultramid® A3X2G7, which are fixed and arranged in such a way, the quenching response of the arc quenching device can be considerably improved. Other solutions, which are more complex in terms of fitting technology, for stabilizing the arc within the splitter stack, for example in the form of the arc guide elements known from DE 102 50 950 B4 consisting of copper—are no longer required. Any risk to personnel, for example as a result of quenching failure in the event of a short circuit, is in this case reliably ruled out, with the result that no further protective measures, in particular no additional protective covers for the insulating walls, are required.

Owing to the glass-fiber reinforcement of the gassing plastic of which the parts 50 consist, the structure of the parts 50 is maintained, with the result that it is possible to prevent the parts 50 from becoming detached and falling off even in the event of frequent interaction with switching arcs.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An arc quenching device for an electrical switch, comprising:
a plurality of arc splitters arranged parallel to one another; and
at least one part, consisting of gassing plastic, extending parallel to an arc running direction so as to cover at least two of the plurality of arc splitters.

2. The arc quenching device as claimed in claim 1, wherein the at least one gassing part covers all of the splitters.

3. The arc quenching device as claimed in claim 1, wherein two of the gassing parts are provided and are formed as areal strips and are arranged below the splitters.

4. The arc quenching device as claimed in claim 1, wherein the splitters are arranged between two arc guide plates, which run parallel to them, the two areal strips each being fixed on the two arc guide plates.

5. The arc quenching device as claimed in claim 4, wherein the arc guide plates and the areal strips are provided with at least one corresponding latching device.

6. The arc quenching device as claimed in claim 5, wherein the arc guide plates have projections which engage in associated cutouts of the gassing parts.

7. The arc quenching device as claimed in claim 4, wherein, in order to fix the splitters and the arc guide plates, two insulating walls are provided which extend parallel to the arc running direction, and wherein in each case, one of the flat sides of the two strips which run parallel to the insulating walls is supported on one of the insulating walls.

8. The arc quenching device as claimed in claim 1, wherein the gassing plastic is glass-fiber-reinforced.

9. The arc quenching device as claimed in claim 8, wherein the gassing plastic contains an additive consisting of red phosphor.

10. The arc quenching device as claimed in claim 8, wherein Ultramid® A3X2G7 is used as the gassing plastic.

11. An electrical switch comprising an arc quenching device designed as claimed in claim 1.

12. The arc quenching device as claimed in claim 2, wherein two of the gassing parts are provided and are formed as areal strips and are arranged below the splitters.

13. The arc quenching device as claimed in claim 2, wherein the splitters are arranged between two arc guide plates, which run parallel to them, the two areal strips each being fixed on the two arc guide plates.

14. The arc quenching device as claimed in claim 13, wherein the arc guide plates and the areal strips are provided with at least one corresponding latching device.

15. The arc quenching device as claimed in claim 14, wherein the arc guide plates have projections which engage in associated cutouts of the gassing parts.

16. The arc quenching device as claimed in claim 5, wherein, in order to fix the splitters and the arc guide plates, two insulating walls are provided which extend parallel to the arc running direction, and wherein in each case, one of the flat sides of the two strips which run parallel to the insulating walls is supported on one of the insulating walls.

17. The arc quenching device as claimed in claim 6, wherein, in order to fix the splitters and the arc guide plates, two insulating walls are provided which extend parallel to the arc running direction, and wherein in each case, one of the flat sides of the two strips which run parallel to the insulating walls is supported on one of the insulating walls.

18. The arc quenching device as claimed in claim 9, wherein Ultramid® A3X2G7 is used as the gassing plastic.

19. An electrical switch comprising an arc quenching device designed as claimed in claim 2.

20. An electrical switch comprising an arc quenching device designed as claimed in claim 3.
